(19) United States
(12) Patent Application Publication
(10) Pub. No.: US 2003/0033149 A1
(43) Pub. Date: Feb. 13, 2003

(54) Methods and systems of simulating movement accompanying speech

(76) Inventors: Stephen Milligan, Carrboro, NC (US); Elena Novikova, Fairfax, VA (US)

Correspondence Address: KILPATRICK STOCKTON LLP, 3737 GLENWOOD AVENUE, SUITE 400, RALEIGH, NC, 27612, US

(21) Appl. No.: 09/808,754

(22) Filed: Mar. 15, 2001

(51) Int. Cl. G10L 21/00

(52) U.S. Cl. 704/275

(57) ABSTRACT

A method of simulating movement during speech. The method includes deriving the timing and features of linguistic stress from an audio source. On/off characteristics of speech and the rate of speech are also derived from the audio source. Stresses are categorized based on the feature of the stresses, the relationship between the stresses, and the on/off characteristics of speech. Appropriate gestures are chosen for each stress and are placed relative to the stresses. Gestures are modified by the rate of speech. New gestures are introduced and existing gestures are modified based on rules which examine the distribution of gestures in the speech and the on/off characteristics of speech. Background movement is generated, consisting of states and rules for choosing states and transitioning between them based on the on/off characteristics of speech and the rate of speech.

### BACKGROUND OF THE INVENTION

1. Field of the Invention

This invention generally relates to computer animation, specifically to methods for driving computer animated characters to simulate those motions which accompany speech.

2. Description of the Related Art

Spoken performances by computer animated characters are a common and desirable feature of games, advertising, animated agents, and animated electronic communication. A satisfying spoken performance by an animated character involves at least two distinct elements. First, the character must lip-synch the speech well, i.e. the motion of the mouth and jaw must give the illusion that the character is producing the words which we hear. Second, the character must execute movements, particularly of the face and head, in a manner similar to a human speaker, i.e. it should nod its head when a person might nod his or her head, blink when a person might blink, etc. This adds the illusion that the character is not only speaking, but thinking. It is this second element of spoken performance with which this invention is concerned.

Motions accompanying speech occur for many different reasons and in response to various stimuli, both internal and external. For example, speakers move their heads and eyebrows to emphasize particular words, or to indicate that they have finished speaking. The result is a complex, continuous dance of facial gesturing, head movement, hand gestures, and body language which is carefully coordinated with the rhythms of speech. Humans read this kind of information as an important non-verbal channel of communication which facilitate the listener's understanding. Thus, timing and appropriateness must be carefully considered for every motion in an animation, no matter how subtle.

Convincingly animating the motions accompanying speech is the time-consuming and arduous task of highly skilled character animators. Because of the difficulty of the task and the rarity of the skills involved, or because of a production model which requires automatic animation, many animations feature characters whose gestures are either inappropriate to their speech (often simply random), or altogether missing. In either case the viewer is left unsatisfied with and unconvinced by the character's spoken performance. Also, as automatic lip synching methods are increasingly developed and applied, it will be desirable to apply a complementary method to automatically simulate the additional motions necessary for a satisfying spoken performance.

Consequently there is a need in the art for methods and systems of animating movements which accompany speech.

### BRIEF SUMMARY OF THE INVENTION

In accordance with the system and method disclosed herein, movement is simulated for an animated character during speech. A computer program generates gestures based on at least one of the following: features of linguistic stress, the on/off characteristics of speech, and the rate of speech. The method approximates features of linguistic stress. As used herein, on/off characteristics refers to the presence (on) or absence (off) of speech sounds, rather than acoustical sound or silence. For example, background noise such as music is silence, as used herein, because it does not contain speech.

Preferably, the program approximates features of linguistic stress by deriving a sequence of phonemes from an audio source. The program analyzes the audio source to derive an amplitude integral and energy of vowel segments. The program then determines whether the vowels are stressed or unstressed. For each stress vowel, the program calculates the strength of the stress based on the amplitude integral and the energy of the vowel sement.

The program assigns gestures to stresses based on at least one of the following: the features of the stress, the relationships between stresses, and the on/off characteristics of speech. The stresses are aligned temporally.

Another aspect involves the generation of new gestures and the modification of existing gestures through the formulation and application of rules. These rules consider as their inputs the existing gestures, as well as the on/off characteristics of speech. This allows the resolution of inconsistencies, conflicts, or omissions that have arisen in the pattern of gestures.

Another aspect involves the generation of background movement. Some of the movement accompanying speech does not qualify as gestures as defined herein because some movements do not span a finite time or are not associated temporally with stress. Such movements include the shifting head orientation and the slight movement of eyes across a listener's face during speech and are defined as positional states and transitions. The choice of state and the timing of the transitions are based on the on/off characteristics of speech, the rate of speech, and the on/off characteristics of speech.

Then the program divides the stresses into categories based on characteristics of the stresses themselves, on relationships between the stresses, and on relationships between the stresses and the on/off characteristics of speech. As used herein, an utterance is a speech segment that is in a single continuous piece of speech beginning and ending with silence. An example of an utterance is a sentence of phrase. Preferably, the stress categories are

Then the program divides the stresses into categories based on characteristics of the stresses themselves, on relationships between the stresses, and on relationships between the stresses and the on/off characteristics of speech. As used herein, an utterance is a speech segment that is in a single continuous piece of speech beginning and ending with silence. An example of an utterance is a sentence of phrase. Preferably, the stress categories are as follows:

Initial stress (if the stress is at the beginning of an utterance).

Final stress (if the stress is at the end of an utterance).

Quick stress (if the stress is separated from the next nearest stress by less than a first time

interval, which in the preferred embodiment is approximately 450 ms)

Isolated stress (if the stress is separated from the next nearest stress by more than a second time

interval, which in the preferred embodiment is approximately 1000 ms).

Long stress (if the length of the stress is greater than a third time interval, where the third interval

is preferably set such that the longest 15% of stresses are chosen, which in a preferred embodiment is approximately 120 ms).

Short stress (if the length of the stress is less than a fourth time interval, where the fourth time

interval is preferably set such that the shortest 15% of stresses are chosen, which in a preferred embodiment is approximately 55 ms).

High stress (if the pitch of the stress is greater than a first pitch level, where the first pitch level is

preferably set such that the highest 15% of stresses are chosen, more preferably this level

is determined by comparing the ranges of pitch detected in an audio source or definitive

sample, which is a preferred embodiment is approximately 195 Hz).

Low stress (if the pitch of the stress is lower than a second pitch level, where the second pitch

level is preferably set such that the lowest 15% of stresses are chosen, more preferably this level is determined by comparing the ranges of pitch detected in an audio source or

definitive sample, which is a preferred embodiment is approximately 105 Hz).

Rising stress (if the pitch of the stress rises over time)

Declining stress (if the pitch of the stress lowers over time)

Fast stress (if the stress occurs within an utterance having a rate of speech faster than a first rate

of speech, where the first rate of speech, in terms of average phoneme length, is preferably set such that the fastest 15% of stresses are chosen, which in a preferred embodiment is approximately 42 ms).

Slow stress (if the stress occurs within an utterance having a rate of speech slower than a second

rate of speech, where the second rate of speech, in terms of average phoneme length, is

preferably set such that the slowest 15% of stresses are chosen, which in a preferred embodiment is approximately 120 ms).

Strong stress (if the stress has an energy greater than a first energy, where the first energy is

preferably set such that the strongest 15% of stresses are chosen, more preferably this level is determined by comparing the ranges of energy in an audio source or definitive sample which is a preferred embodiment is approximately 70). As used herein and as defined in greater detail in the Detailed Description below, energy is a measure of strength.

Weak stress (if the stress has an energy less than a second energy, where the second energy is

preferably set such that the weakest 15% of stresses are chosen, more preferably this level

is determined by comparing the ranges of energy in an audio source or definitive sample,

which is a preferred embodiment is approximately 30)

As will be understood by those skilled in the art, the parameters used to categorize stresses will depend on particulars of the inputs and environment in which the invention is embedded. For example, different phoneme recognition systems will detect different numbers of phonemes, affecting rate, length, and proximity of stress calculations. As will also be understood by those skilled in the art of computer programming, these parameters may be adjusted to achieve variation in the output, for example, to make the performance of animation more active or lethargic.

In another aspect, the method defines gestures and aligns them with the detected and categorized stresses. A gesture is a coordinated set of movements spanning a finite time, with a clearly defined peak time which can be temporally aligned with a stress. In accordance with the nature of the inputs derived from the audio source, these gestures must be those which are associated with stress, but not with meaning. There are many such gestures, used by speakers for emphasis, turn-taking, and other forms of non-verbal communication.

Preferably, gestures are represented by individual component elements. Thus, a gesture may include a multiple movements that are each represented by separate elements. Each element has a function curve for specifying the amplitude of the element with respect to time. More preferably, each of the element actions of a gesture may be adjusted according to the rate of speech. Most preferably, gestures elements are adjusted using a stretch/compress coefficient.

In yet another aspect, a system stimulates movement during speech. The system includes a program on a computer system for generating an animated character, which has animation gestures associated therewith. The computer program generates gestures based on the features of linguistic stress, the on/off characteristics of speech and the rate of speech.

### BRIEF DESCRIPTION OF THE SEVERAL VIEWS OF THE DRAWINGS

These and other features, aspects, and advantages of the present invention are better understood when the following Detailed Description of the Invention is read with reference to the accompanying drawings, wherein:

FIGS. 1 and 2 are block diagrams illustrating the operating environment for the present invention;

FIG. 3 is a flowchart describing the Speech Movement Implementation shown in FIGS. 1 and 2;

FIG. 4 illustrates the calculation of positive maxima and negative minima of a phoneme;

FIG. 5 illustrates the calculation of average amplitude and energy of a phoneme;

FIG. 6 shows a function curve representation of a sample gesture;

FIG. 7 shows the calculation of stretch/compress coefficient from rate of speech.

FIG. 8 shows the results of a rate of speech adjustment on a sample gesture;

FIG. 8 shows partial results of the algorithm for a sample utterance.

FIG. 10 shows the effect of rules on a sample utterance.

FIG. 11 shows head orientation states and transitions for a sample utterance.

FIG. 12 shows eye states and transitions for a sample utterance

### DETAILED DESCRIPTION OF THE INVENTION

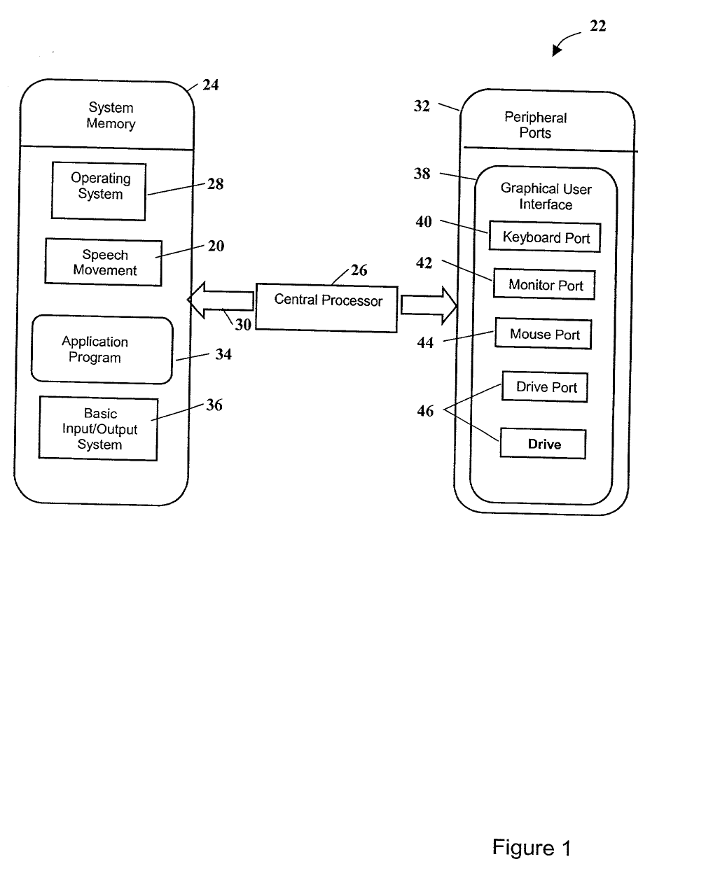

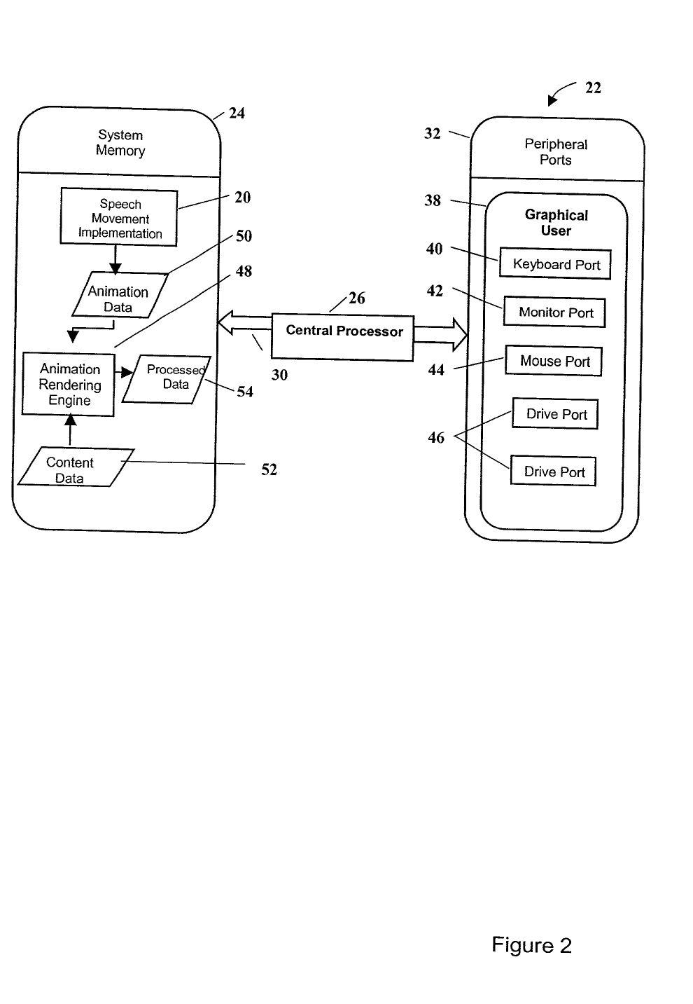

FIGS. 1 and 2 show the operating environment for the present invention. The present invention is a computer program that simulates the movements of a human speaker during speech. As those skilled in the art of computer programming recognize, computer programs are depicted as process and symbolic representations of computer operations. Computer components, such as a central processor, memory devices, and display devices, execute these computer operations. The computer operations include manipulation of data bits by the central processor, and the memory devices maintain the data bits in data structures. The process and symbolic representations are understood, by those skilled in the art of computer programming, to convey the discoveries in the art and the invention disclosed herein.

FIG. 1 is a block diagram showing a computer program for simulating movement during speech, shown as Speech Movement Implementation 20, residing in a computer system 22. The Speech Movement Implementation 20 is stored within a system memory device 24. The computer system 22 also has a central processor 26 capable of executing an operating system 28. The operating system 28 also resides within the system memory device 24. The operating system 28 has a set of instructions that control the internal functions of the computer system 22. The operating system 28 controls internal functions in a conventional manner and well known to those of ordinary skill in the art. A system bus 30 communicates signals, such as data signals, control signals, and address signals, between the central processor 26, the system memory device 24, and at least one peripheral port 32. While the computer system 22 described, in a typical configuration, is a workstation available from Hewlett Packard, those of ordinary skill in the art understand that the program, processes, methods, and systems described in this patent are not limited to any particular computer system.

Those of ordinary skill in art also understand the central processor 26 is typically a microprocessor. Such microprocessors may include those available from Advanced Micro Devices under the name ATHLON™, and those available from The Intel Corporation under the general family of X86 and P86 microprocessors. While only one microprocessor is shown, those of ordinary skill in the art also recognize multiple processors may be utilized. Those of ordinary skill in the art well further understand that the program, processes, methods, and systems described in this patent are not limited to any particular manufacturer's central processor.

The system memory 24 also contains an application program 34 and a Basic Input/Output System (BIOS) program 36. The application program 34 cooperates with the operating system 28 and with the at least one peripheral port 32 to provide a Graphical User Interface (GUI) 38. The Graphical User Interface 38 is typically a combination of signals communicated along a keyboard port 40, a monitor port 42, a mouse port 44, and one or more drive ports 46. The Basic Input/Output System 36, as is well known in the art, interprets requests from the operating system 28. The Basic Input/Output System 36 then interfaces with the keyboard port 40, the monitor port 42, the mouse port 44, and the drive ports 46 to execute the request.

The operating system 28 may be one such as that available from the Microsoft Corporation under the name WINDOWS NT®. The WINDOWS NT® operating system is typically preinstalled in the system memory device 24 on the aforementioned Hewlett Packard workstation. Those of ordinary skill in the art also recognize many other operating systems are suitable, such as those available under the name UNIX® from the Open Source Group, the UNIX-based open source Linux operating system, and that available from Apple Computer, Inc. under the name Mac® OS. Those of ordinary skill in the art will again understand that the program, processes, methods, and systems described in this patent are not limited to any particular operating system.

FIG. 2 is also a block diagram showing the operating environment for the present invention. Speech Movement Implementation 20 resides within the system memory 24. An animation-rendering engine 48 also resides within the system memory 24. The animation rendering engine 48 is a computer program that allows animators to turn 3-Dimensional views into a 2-Dimensional display image. The animation rendering engine 48 may add realistic lighting techniques to the 2-Dimensional display image, such as shading, simulated shadows, reflection, and refraction. The animation rendering engine 48 may also include the application of textures to the surfaces. The Speech Movement Implementation 20 produces animation data 50. As those of ordinary skill in the art of computer animation understand, the animation rendering engine 48 accepts the animation data 50 and combines the animation data 50 with content data 52. The animation rendering engine 48 processes the animation data 50 and the content data 52 and produces processed data 54. The processed data 54 is sent along the system bus 30 to the Graphical User Interface 38. The processed data 54 is then passed through the monitor port 42 and displayed on a monitor (not shown). The animation data 50 produced by the Speech Movement Implementation 20 drives animated characters to perform realistic speech movements.

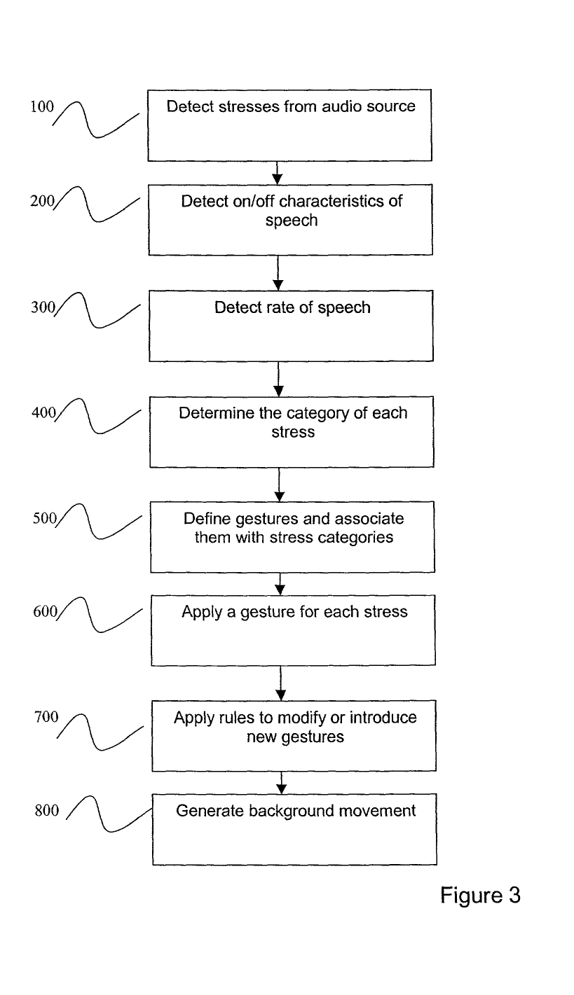

FIG.3 is a flowchart describing the Speech Movement Implementation. Speech Movement Implementation is a method of simulating the movement of a human speaker during speech. This method provides realistic movement for a variety of uses. One such use includes talking, animated characters. The method allows a user to customize various parameters to adjust the movements performed during speech. The method thus permits a user to create realistic movement, regardless of the content of the speech. As FIG. 3 shows, the method of the present invention includes Steps 100 through 700.

At Step 100 a list of stresses is detected from an audio source.

In the following example, stressed syllables are upper case, and unstressed are lower case.

JACK spent FIVE YEARS on the BOTtom of the DEEP BLUE SEA.

The exact stresses in an utterance are dependent on the speaker and the performance of the utterance. It is possible to stress an utterance many different ways, depending on intent, accent, and other variables.

In order to detect the actual stressed syllables in a particular audio source, first the Speech Movement Implementation derives a phoneme segmentation from the audio source. As understood by those skilled in the art, a phoneme is an phonetic sound unit. As those familiar with speech recognition systems will recognize, a phoneme segmentation is a time-coded list of the phonemes present in an audio source. A phoneme segmentation can be performed by a commercially-available speech recognition system, such as is available from SoftSound Limited (SoftSound LTD., St John's Innovation Centre, Cowley Road, Cambridge CB4 OWS United Kingdom).

Since stress can be considered a feature of syllables (i.e. an entire syllable is considered stressed or unstressed, not its constituent phonemes), and syllables contain in general a single vowel sound, only the vowels in the phoneme segmentation need be considered. That is, in the previous example, the stresses would be detected as follows:

jAck spent five yEArs on the bOttom of the dEEp blUE sEA.

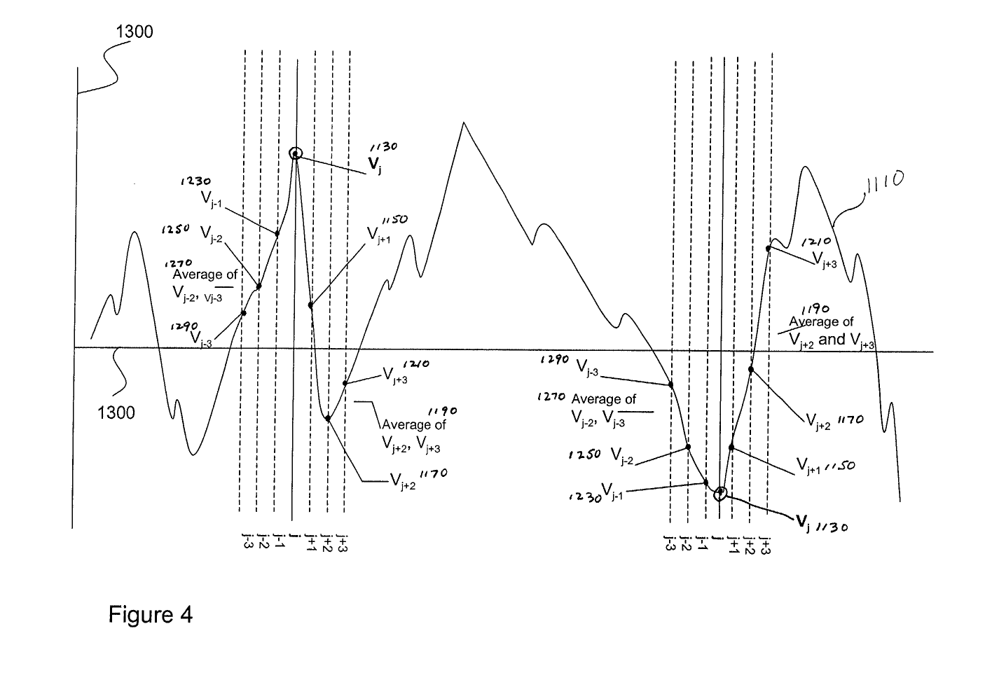

The Speech Movement Implementation calculates two quantities for each vowel detected: average amplitude and energy. These calculations depend on finding the negative minima and positive maxima for data points inside the time range of the vowel. Referring to FIG. 4, the audio signal 1110 (having an amplitude 1300) is shown as a function of time 1310. The audio signal 1110 is examined at successive data time points 1130, 1150, 1170, 1190, 1210, 1230, 1250, 1270, and 1290. Preferably, for an audio source sampled at a given frequency, the interval between points may be the inverse of the frequency. For example, for an audio source sampled at 16MHz, the interval between points is 0.0625 ms. A positive maximum as used herein is defined as any time point j 1130 at which the value of j 1130 is positive and greater than the following:

a) the value at j−1 1230

b) the value at j+1 1150

c) the average of values at (j−2) and (j−3) 1270

d) the avearage of values at (j+2) and (J+3) 1190

While not shown, a negative minimum is calculated using the inverse of the same method, such that a negative minimum occurs at time point j if the value at j is negative, and less than the value at j−1, the value at j+1, the average of values at (j−2) and (j−3), and the average of values at (j+2) and (j+3).

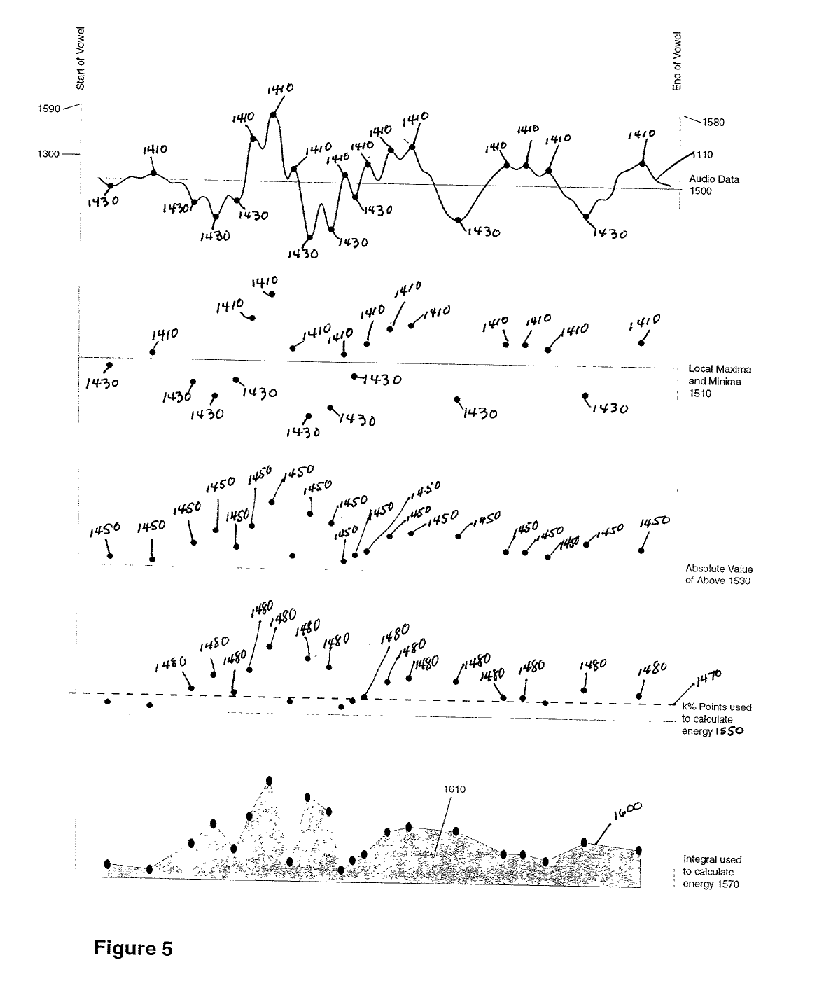

FIG. 5 illustrates the calculation of the average amplitude and energy of a phoneme that is calculated by the Speech Movement Implementation.

The graphs of FIG. 5 1500 shows data as a function of amplitude 1300 and frequency 1310 for a vowel sound starting at a given time 1590 and ending at a given time 1580. The first graph 1500 shows the audio data 1110 and the previously calculated positive maxima 1410 and negative minima 1430. The second graph 1510 is a simplified graph showing only the values of the positive maxima 1410 and negative minima 1430. The third graph 1530 shows the absolute values 1450 of the local maxima and minima.

The fourth graph 1550 illustrates the values from the third graph 1530 where an amplitude cutoff labeled k % 1470 has been selected. The values of the absolute values of the positive maxima and negative minima which are above k % 1480 are averaged to find the average amplitude. The value of k can be adjusted to tune the output. Preferably, the value of k % is about 25%.

The fifth graph shows a curve 1600 that graphs the value of all positive maxima and negative minima squared. This curve represents the smoothed power as a function of time. The energy of the vowel sound is the area 1610 underneath the curve 1600, or the integral of the curve 1600. Integration may be performed using a standard numerical integration method.

The values for average amplitude are normalized, and compared to a threshold value which can be adjusted to tune the output. Likewise, the values for average energy are normalized, and compared to a threshold value which can be adjusted to tune the output. Vowels which score above the threshold on both quantities are considered stressed. Each stress is assigned a peak time, that is, the time with which its associated gesture must be aligned. By aligned it is meant that any gesture which accompanies this stress will reach its peak at the stress peak time. The stress peak time is set to be the leading time boundary of the stressed vowel phoneme.

The energy is also stored in the Speech Movement Implementation with the stress. As used herein, energy is a measure of the strength of a stress. Other useful features of the stress such as its pitch or inflection may be stored with the stress at this time as well, for use in the calculations which follow. Thus, step 100 in FIG. 3 produces a list of stresses and stress characteristics in the audio source. Following is an example consisting of detected stresses in the utterance “Jack spent five years on the bottom of the deep blue sea,” calculated by the method described above.

| Stress | Stress Peak Time | Stress Strength. |
|---|---|---|
| 1 | 85 ms | 23 |
| 2 | 251 ms | 48 |
| 3 | 426 ms | 64 |
| 4 | 493 ms | 21 |
| 5 | 539 ms | 89 |
| 6 | 613 ms | 42 |
| 7 | 742 ms | 43 |

The resulting stresses approximate the phenomenon that linguists and those skilled in the art commonly call “linguistic stress.“ Linguistic stress is usually defined by those skilled in the art in terms of something a speaker does in one part of an utterance relative to another. A linguistically stressed syllable may be louder, have a longer vowel, a higher pitch than unstressed syllables, but these qualities are not always present in a stressed syllable, nor does their absence necessarily preclude the syllable's being stressed (Ladefoged, A Course In Phonetics, Third Edition, Harcourt/Brace, 1975, pp 113). For these reasons, in general it is very difficult to accurately determine linguistic stress in an audio source; and the above method provides a good approximation. Such an approximation is very useful for simulating gestures.

Furthermore, as would be understood by one of ordinary skill in the art, there are many possible methods for detecting or approximating the detection of linguistic stress. For example, a simple lookup table can be used to determine which syllable in a word is most likely to be stressed. As noted above, stress is also connected with pitch, phoneme length, and various other features of speech, which can be analyzed to extract stress, with or without the aid of a phoneme segmentation. According to FIG. 3, if some approximation of stress has been achieved in step 100, the rest of the algorithm can proceed, and the quality of the end result will scale according to the accuracy of the stress detection.

In step 200, in FIG. 3, the Speech Movement Implementation detects the sounds and silences in speech, called on/off characteristics from the audio input. The on/off characteristics considered are:

Beginning of Utterance: At what time does the utterance start?

End of Utterance: At what time does the utterance end?

Beginning of Pause: At what time do pauses of greater than a given duration start.

End of Pause: At what time do pauses of greater than a given duration end.

An utterance is defined as a sequence of phonemes which is bounded at either end by (but does not contain) silences longer than some defined duration. As used herein, silence is an absence of speech sounds, rather than acoustic silence. For example, background noise such as music is silence, as used herein, because it does not contain speech. A pause is a silence which is shorter than this duration, but greater than some minimum duration, so as to exclude the insignificant silences which occur within or between words. As would be understood by one of ordinary skill in the art, the lengths of silences in the audio input can be measured using a VAD (voice activity detector) or simply read from the phoneme segmentation.

The result is a list of on/off characteristics of speech, such as the following for a single utterance:

| On/Off Characteristic | Time |
|---|---|
| Beginning of Utterance | 85 ms |
| Pause | 251 ms |
| Pause | 426 ms |
| End of Utterance | 800 ms |

In step 300 of FIG. 3 the Rate of Speech is measured. The Rate of Speech is a quantity reflecting how quickly the audio input was spoken, so that the speed of movement can be adjusted appropriately. The average length of segments in the audio input is calculated. This average length can then be compared against an average rate previously determined from analysis of a wide variety of human speech. From this comparison coefficients can be calculated which can be used to adjust the speed of movements, as happens when humans speak quickly or slowly.

In step 400 the stresses are divided into categories. These categories are chosen so as to be useful for associating certain gestures with certain types of stresses. For example, a person is more likely to make a decisive, strong head motion at the end of an utterance than in the middle. If several stresses follow each other quickly, the gestures associated with them are also likely to be quick. If a stress is particularly isolated in an utterance, it is likely to be a accompanied by a particularly strong gesture. Other gestures may be excluded from a particular category. For example, a gesture which causes the head to tilt to the side, when placed at the end of an utterance, will tend to make the speaker look like he or she was asking a question. Since it is not clear from any of the inputs derived from the audio source whether or not an utterance is a question, this should be avoided. Thus for the category of stresses which occur at the end of utterances, these gestures are excluded.

The rules for categorizing stresses must choose the category based on the inputs derived from the audio source. These fall into several groups:

1) Rules which choose a category based on the relationships between the stresses and the on/off characteristics of speech:

a. If this is the first stress after the Beginning of Utterance, it is an Initial Stress

b. If this is the last stress before the End of Utterance, it is a Final Stress

2) Rules which choose a category based on the relationships between the stresses themselves.

a. If the stress is separated from its nearest neighbor in time by less than a given interval, it is a quick stress.

b. If the stress is separated from its nearest neighbor by a time greater than a given interval, it is an isolated stress

3) Rules which choose a category based on the characteristics of the stress itself

a. If the length of the stressed phoneme is greater than a given interval, it is a Long Stress

b. If a stress has greater energy than a certain value, it is a Strong Stress

c. If a stress has a high pitch it is a High Stress

d. If a stress has a rising inflection it is a Rising Stress

Etc.

4) Rules which choose a category based on the rate of speech

a. If the stress occurs in a section of the audio source where the rate of speech is fast, it is a fast stress

b. If the stress occurs in a section of the audio source where the rate of speech is slow, it is a slow stress

Etc.

Finally, a stress for which no category is established by the explicit rules is a Normal Stress.

Thus, the particular categories chosen as an example implementation are as follows:

Initial

Final

Quick

Isolated

Normal

Returning to the sample utterance, following are the categories into which each stress is placed:

JACK spent FIVE YEARS on the BOTtom of the DEEP BLUE SEA.

| Initial | Quick Quick | Isolated | Normal Normal Final. |
|---|---|---|---|
| Stress | Stress Peak Time | Stress Strength | Stress Category |
| 1 | 85 ms | 23 | Initial |
| 2 | 251 ms | 48 | Quick |
| 3 | 426 ms | 64 | Quick |
| 4 | 493 ms | 21 | Isolated |
| 5 | 539 ms | 89 | Normal |
| 6 | 613 ms | 42 | Normal |
| 7 | 742 ms | 43 | Final |

Again, as long as a correlation can be established between a category and a set of actions, and the audio inputs are sufficient to define a set of rules which can determine the which stresses fall into the category, the category is valid and useful, and the algorithm can produce results. The quality of the results scales with the appropriateness of the categories for deciding on gestures.

In Step 500 gestures are defined and associated with stress categories. First, a list of gestures must be compiled. A gesture is defined as a coordinated set of movements spanning a finite time, with a clearly defined peak time. The peak time is the complement of the peak time for stress, i.e. it is the point of temporal alignment between the gesture and the stress. An example is a gesture which contains a head nod, an eyebrow raise, and a blink. The peak time of the action is concurrent with the change in direction of the head as it reaches the bottom of the nod. It is this point in the gesture which will be aligned with a stress. Thus, the head will start moving before the stressed vowel is spoken, and will reach its peak time just as the beginning of that vowel is reached.

Preferably, a gesture is one which can be safely associated with a category of stress without risk of inappropriateness, and is not dependent on additional inputs which may not available. For example, humans will sometimes wink to emphasize a stress, if the intent is to be humorous or sly. However, if the intent was to emphasize the stress to convey importance or seriousness, producing a wink would be considered a catastrophic failure of the invention. Since the intent cannot be derived from the audio inputs, a wink is not a gesture which can be realistically simulated by the method and system disclosed herein. Fortunately there are a number of gestures which are associated with stress, but not with meaning.

An example list of appropriate gestures is as follows:

Strong Head Nod

Inverted Head Nod

Quick Head Nod

Normal Head Nod

Eyebrow Raise

Head Roll (side to side tilting)

Head Yaw (turning)

Blink

As would be understood by one of ordinary skill in the art, other gestures could be included in this list, covering a broad range of actions, such as “chop air with left hand”, “push up glasses” or “wiggle antennae.” The invention is capable of controlling any gesture which spans a finite time and can be associated with a category derived from the audio inputs.

The actions must be defined in a manner suitable for simulation. As will be recognized by those skilled in the art of computer graphics, function curves provide such a suitable representation. A function curve is a mathematical representation of the amplitude of an animatable quantity (such as the degree to which an eyebrow is raised or the angle at which a head is turned) with respect to time. As those of ordinary skill in the art of programming and mathematics recognize, a function curve can be interpolated between a set of control points. A control point is a point corresponding to the amplitude of an animatable quantity and derivative (which may be calculated) for a particular instant in time. By altering the time, amplitude, and derivative of the points, the shape of the function curves can be manipulated so that all the components of a gesture are aligned to a stress. Because a gesture is a coordinated set of component actions, each gesture consists of at least one and usually more than one function curve. Thus, a gesture has at least one function curve for each component element of motion.

An example of components which comprise each gesture may include the following:

Degree of blink(Left/Right)

Degree of eyebrow raise (Left/Right)

Head Pitch (nodding angle)

Head Yaw (turning angle)

Head Roll (tilting angle)

As would be understood by one of ordinary skill in the art, the list of components could easily be expanded to include additional components as needed for other gestures. For example a gesture such as “chop air with left hand” would require that this list be extended to include angles for all the joints involved in moving the hand.

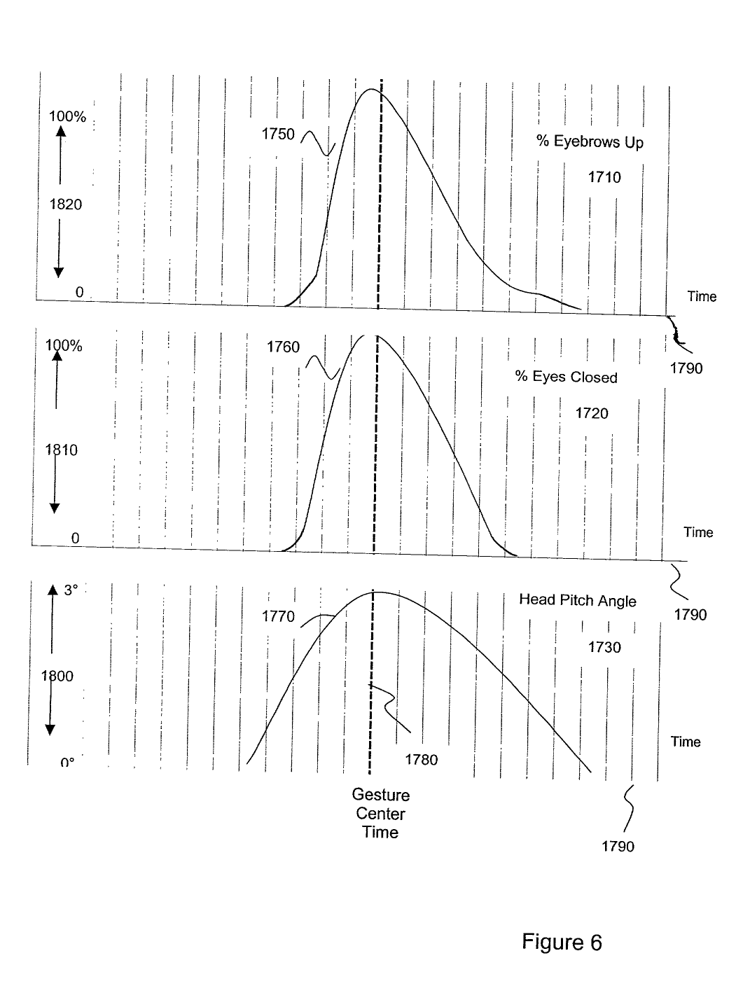

FIG. 6 shows a sample function curve representation of a Quick Head Nod, which has three elements: eyebrow motion, eye motion, and head pitch angle. The motion for the eyebrows in the top graph 1710, eyes in the middle graph 1720, and head pitch angle in the bottom graph 1730 are shown. The gesture is centered around a specified gesture center time 1780. The percentage that the eyebrows are up 1820 is shown as a curve 1750 graphed as a function of time 1790. The percentage that the eyes are closed 1810 is shown as a curve 1760 graphed as a function of time 1790. The head pitch angle 1800 is shown is shown as a curve 1770 graphed as a function of time 1790.

The function curves 1750, 1760, and 1770 are defined by the Speech Movement Implementation as interpolations between control points. Table 1 below shows the time, value (also referred to as the amplitude of animatable motion) and derivatives of the control points for the gesture depicted in FIG. 6:

TABLE 1
Quick Head Nod

| | 1^{ST} Control | 1^{st} Control | 2^{nd} Control | 2^{nd} Control | 3^{rd} Control | 3^{rd} Control | Probability of |
|---|---|---|---|---|---|---|---|
| | Point Time | Point Value | Point Time | Point Value | Point Time | Point Value | Component |
| | Offset (ms) | (Amplitude) | Offset (ms) | (Amplitude) | Offset (ms) | (Amplitude) | inclusion |
| Eyebrows Up | −90 | 0 | −45 | 0.2 | 270 | 0 | 0.1 |
| Eyes Closed | −90 | 0 | 0 | 1 | 180 | 0 | 0.1 |
| Head Pitch Angle | −225 | 0 | 0 | 2 | 495 | 0 | 1 |
| Head Roll Angle | 0 | 0 | 0 | 0 | 0 | 0 | 0 |
| Head Yaw Angle | 0 | 0 | 0 | 0 | 0 | 0 | 0 |

While three control points are shown for each component, any number could be used. The time values in Table 1 are in milliseconds of time offset from the peak time of the gesture. Thus, the gesture peak time occurs at time 0. The gesture peak times may be aligned with a stress peak time, or the gesture peak time may be offset from the stress peak time by a time interval. The probability of component element inclusion indicates the likelihood that a particular instance of this gesture will contain this component at all. For example, there is only a 10% chance that a Quick Head Nod will involve a blink, so for nine out of ten Quick Head Nods performed, on average, the eyes will remain open. All values and offsets may be subjected to small random variations in order to introduce variety into particular instances of the gestures. Some values may also be multiplied by —1 in order to produce gestures such as Head Yaw to both the left and right.

The time parameters of gestures are subject to adjustment based on the Rate of Speech. This reflects the fact that humans tend to perform gestures more quickly when speaking quickly. This effect is limited at either end of the rate of speech spectrum—at a certain point, speaking even more rapidly does not result in more frequent or faster gestures, likewise at the other end of the spectrum, gestures cannot be arbitrarily slow, but have a minimum speed. For this reason a stretch/compress coefficient is calculated from the rate of speech.

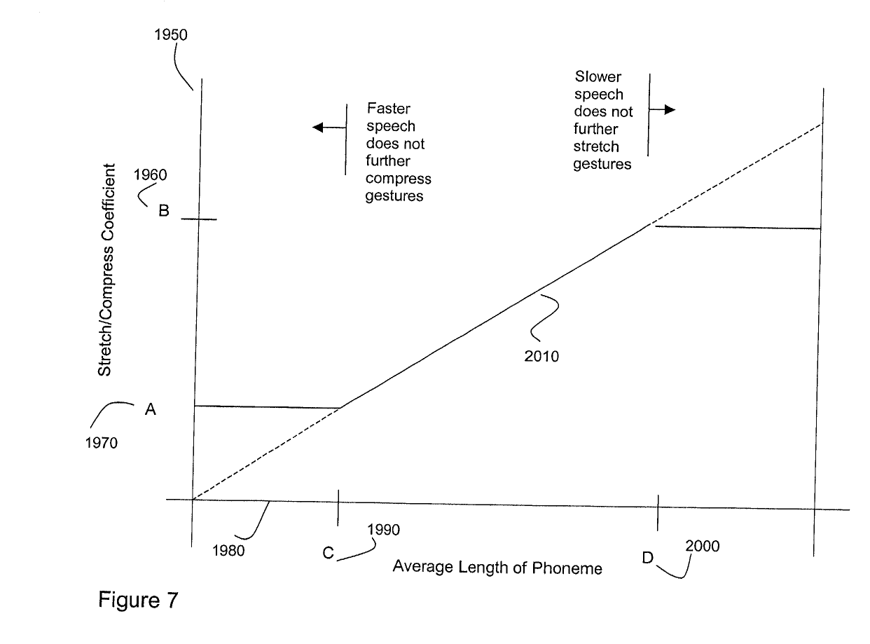

FIG. 7 shows an example of how the stretch/compress coefficient is calculated. The stretch compress coefficient 2010 curve is shown as a function of the stretch/compress coefficient and the average length of a phoneme 1980. The stretch/compress coefficient 2010 ranges between two values, A 1970 and B 1960. In the preferred embodiment, the value for A 1970 is about 0.6 and the value for B 1960 is about 3. In a range between the average length of phoneme located between C 1990 and D 2000, the stretch/compress coefficient 2010 is a function whose value ranges between A 1970 and B 1960. The function 2010 shown in FIG. 7 is linear, however, it could be any function, such as a curve, whose values range between A 1970 and B 1960. For speech where the average length of phonemes 1980 is less than C 1990, the stretch/compress coefficient 2010 remains a minimum value A 1970, and for speech where the average length of phonemes 1980 is greater than D 2000, the stretch/compress coefficient 2010 is a maximum value B 1960. In the preferred embodiment, the value for C is about 45 ms and the value for D is about 200 ms.

Time parameters are selectively adjusted by the stretch/compress coefficient 2010, i.e. some values for movements are left unchanged. This reflects the fact that some characteristics of movement during speech are unaffected by the rate of speech. Blinks, for example, are performed at the same rate regardless of the rate of speech—a person speaking slowly does not necessarily perform each blink more slowly, they simply blink with less frequency. Thus the time parameters reflecting a blink are all shifted by one constant, derived from the rate of speech, rather than individually scaled by the stretch/compress coefficient.

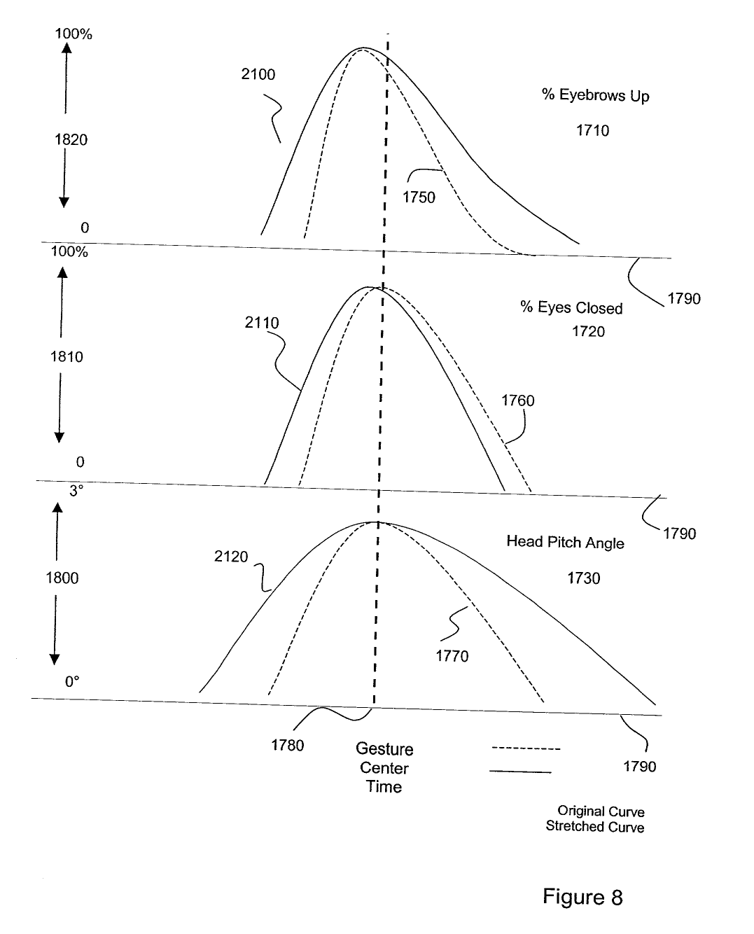

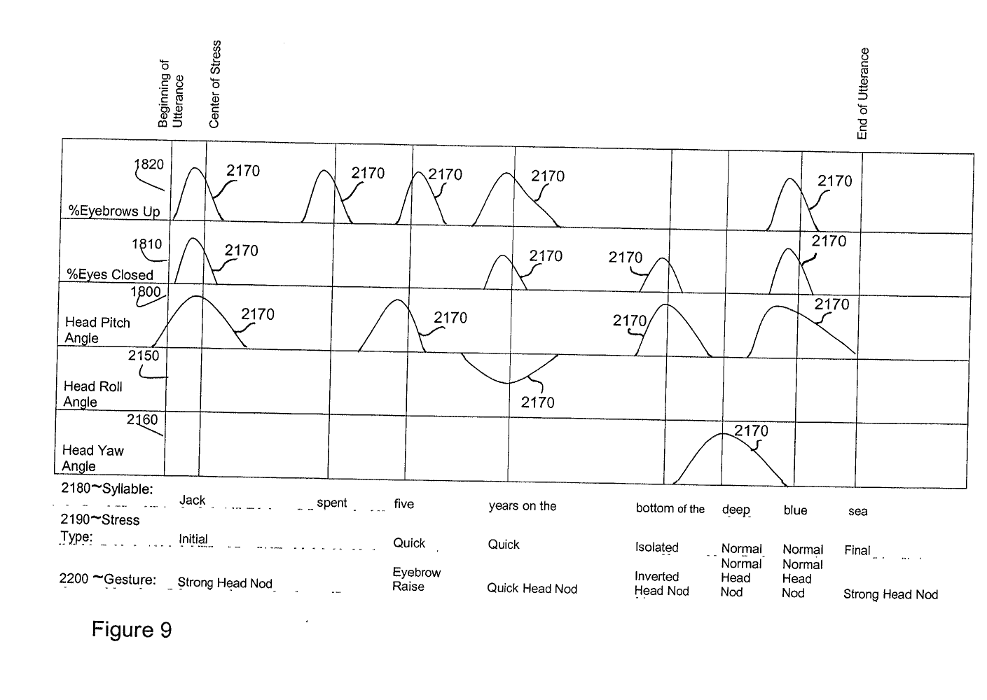

FIG. 8 shows the result of a Rate of Speech adjustment on a particular instance of a quick head nod. FIG. 8 shows the same graphs depicted in FIG. 6 with the addition of function curves scaled by a stretch/compress coefficient that is less than one. The compressed curves are shown for the percentage eyebrows up 2100, percentage eyes closed 2110, and head pitch angle 2120

In step 600 in FIG. 3, gestures are chosen for each stress. The Speech Movement Implementation chooses a particular action which is to be performed for each stress from a table which references actions to stress categories. Which action in particular is chosen from the column of appropriate actions is based on the probability entry in the table. For example, a probability of 0 indicates that that gesture will never be used with that category of stress, a probability of 1 indicates that every stress of that category will be accompanied by this gesture. “No Gesture” entry is provided for the case in which no gesture is to be performed with that stress. As would be understood by one of ordinary skill in the art, the gestures may be chosen with these probabilities using a random number generator.

For the categories and gestures that may be implemented in the Speech Movement Implementation, an example of the table is as follows:

TABLE 2
Stress Type

| | | Initial | Final | Quick | Isolated | Normal |
|---|---|---|---|---|---|---|
| Gesture | No Gesture | 0.00 | 0.00 | 0.00 | 0.00 | 0.00 |
| | Strong Head Nod | 0.38 | 0.38 | 0.00 | 0.28 | 0.13 |
| | Inverted Head Nod | 0.12 | 0.00 | 0.00 | 0.28 | 0.13 |
| | Quick Head Nod | 0.08 | 0.14 | 0.38 | 0.06 | 0.06 |
| | Normal Head Nod | 0.15 | 0.24 | 0.00 | 0.14 | 0.31 |
| | Eyebrow Raise | 0.04 | 0.05 | 0.31 | 0.03 | 0.06 |
| | Head Roll | 0.12 | 0.09 | 0.15 | 0.11 | 0.16 |
| | Head Yaw | 0.12 | 0.09 | 0.15 | 0.11 | 0.16 |

For the utterance “Jack spent five years on the bottom of the deep blue sea,” the gestures chosen might be as follows:

| Syllable | Stress Category | Gesture |
|---|---|---|
| Jack | Initial | Strong Head Nod |
| spent | | |
| five | Quick | Eyebrow Raise |
| years | Quick | Quick Head Nod |
| on | | |
| the | | |
| bot- | Isolated | Inverted Head Nod |
| tom | | |
| of | | |
| the | | |
| deep | Normal | Normal Head Nod |
| blue | Normal | Head Yaw |
| sea. | Final | Strong Head Nod |

As would be understood by one of ordinary skill in the art, if the Speech Movement Implementation chooses a second set of gestures for the same audio source, it might choose differently based on the random number generator. However, the gestures would still be appropriate, as might be analogous to a human performing the speech on separate occasions.

FIG. 9 shows the results of the algorithm for the example above for the utterance “Jack spent five years on the bottom of the deep blue sea.” Function curves 2170 are shown for the example characteristics of the percentage that the eyebrows are depicted up 1820, the percentage that the eyes are closed 1810, the head pitch angle 1800, the head roll angle 2150, and the head yaw angle 2160. The function curves 2170 are generated by the Speech Movement Implementation as described herein based on the gesture 2200 and stress type 2190 associated with each syllable 2180. As discussed above, the Speech Movement Implementation generates movement elements 1820, 1810, 1800, 2150, and 2160 for each gesture 2200 and stress type 2190. The function curves 2170 may be further adjusted based on the rate of speech using the stress/compress coefficient described in FIG. 8 and the accompanying discussion.

In Step 700 in FIG. 3, rules are applied to modify or introduce new gestures based on the pattern of existing gestures and the on/off characteristics of speech.

Some movements which humans perform during speech are unrelated to stresses. It may also be desirable to introduce gestures where no stress was detected. The rules governing such gestures fall into two groups:

1) Rules based on gestures which have already been established by the Speech Movement Implementation:

For example, the Speech Movement Implementation as described above will cause the character to blink, but the blinks may be separated by a wide interval, whereas humans must blink periodically to keep their eyes wet. Thus, if there has been no blink for a defined interval, the Speech Movement Implementation adds a blink.

2) Rules based on the on/off characteristics (sounds and silences) of speech.

a. For another example, research has shown that humans often blink after the end of a sentence. Thus, the Speech Movement Implementation ads a blink a given number of milliseconds after the end of utterance, with a specified probability.

b. Similarly, humans often blink during pauses in speech. Thus, the Speech Movement Implementation adds a blink a given number of milliseconds after a beginning of pause, with a specified probability. Preferably, a blink is introduced about 500 ms after the end of an utterance or pause, with about 75% probability.

Such use of rules also allows for the clean-up and modification of actions which may result from poor stress detection, categorization, or action definition. As would be understood by one of ordinary skill in the art, the rules described above are examples of how to generate gestures where no stress is detected. Many similar rules may be established in the Speech Movement Implementation. Furthermore, rules can be established in the Speech Movement Implementation to delete or modify actions which occur too close to each other, or as described above, to introduce actions where they are needed but have not been placed by the Speech Movement Implementation based on stress.

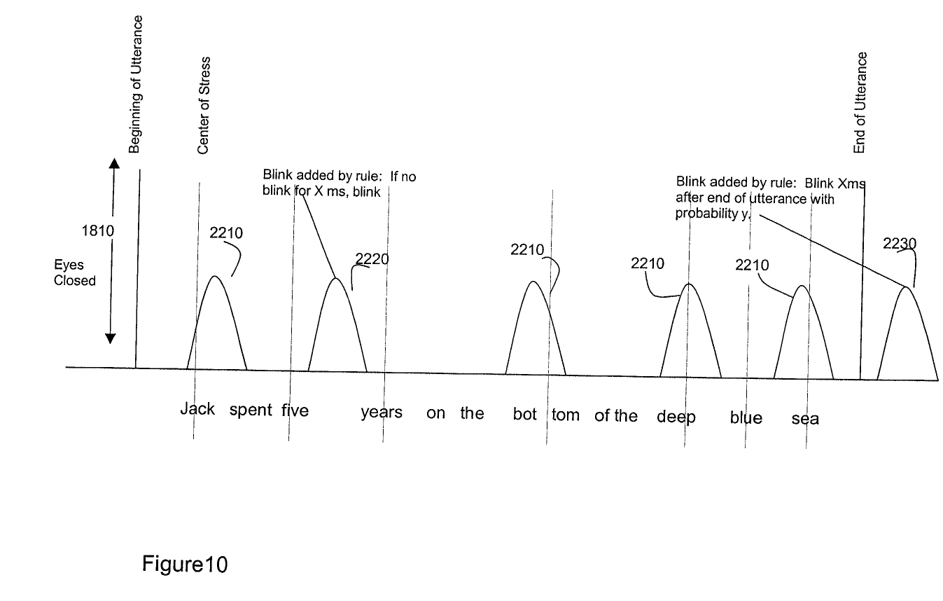

FIG. 10 is an illustration of the effect of such rules on the utterance “Jack spent five years on the bottom of the deep blue sea.” FIG. 10 shows the portion of the graph from

FIG. 9 for the percentage that the animated character's eyes are closed 1810. The function curves 2210, 2220, and 2230 each represent blinks of the animated character's eyes. Function curves 2210 are movement elements of gestures as illustrated in FIG. 9. Function curve 2220 has been added by the Speech Movement Implementation because there has been no blink for a given number of milliseconds, as described in the rule examples. Function curve 2230 has been added by the Speech Movement Implementation because there has been a given number of milliseconds after the beginning of a pause (or end of the utterance).

In step 800 in FIG. 3, background movement is generated. This consists of those movements which do not span a finite interval and are not closely aligned with stresses. A simulation which neglects these motions looks unrealistic and wooden. An example would be a simulation which holds the head in the same orientation throughout the speech, departing only to perform gestures and returning to the same location. The solution is to provide a set of states (orientations or configurations), along with some rules and parameters governing their duration and transition.

Head orientation is controlled by the Speech Movement Implementation. The following table shows the states head orientation can assume.

TABLE 3
Head Orientation States

| Component | probability | X angle | Y angle | Z angle |
|---|---|---|---|---|
| Head Up/Down | 0.5 | 2 | 0 | 0 |
| Head Tilted Left/Right (Roll) | 0.6666 | 0 | 0 | 1.5 |
| Head Turned Left/Right (Yaw) | 0.6666 | 0 | 2 | 0 |

The first column shows the name of the state, the next three contain the angles which define it. The next column shows the probability of assuming this state. Note that the probabilities do not sum to 1. Thus, more than one state can be assumed at a time, in which case the angles are summed, generating a state in which, for example, the head is both turned and tilted. Two more parameters, the transition time between states, and the duration of a state, are globally defined by the Speech Movement Implementation. As would be understood by one of ordinary skill in the art, these values may be subjected to random variations in order to provide variety in specific instances of head orientation state.

Both the duration and transition time are subject to a multiplier which is calculated from the rate of speech. This reflects the fact that human speakers tend to change state more often and more rapidly when speaking quickly. This effect is limited at either end of the rate of speech spectrum—at a certain point, speaking even more rapidly does not result in more frequent or faster state changes, likewise at the other end of the spectrum, state changes have a maximum duration and transition time which are not exceeded as speech gets still slower. Thus, the rate of speech multiplier is capped for both high and low values of rate of speech.

The Speech Movement Implementation establishes a rule for choosing the state based on the on/off characteristics of speech. The head starts in the neutral state. After the beginning of an utterance, the Speech Movement Implementation chooses a new state or states according to the probabilities in Table 3, summing the states if more than one is chosen. After a given duration has elapsed, the Speech Movement Implementation generates the next state based on the probabilities in Table 3 and summing the states if necessary. When the end of utterance occurs, the neutral state is chosen again, and the duration of the previous orientation is adjusted so that the return to neutral occurs at the End of Utterance. This process ensures that the character will not begin or end a sentence with an orientation which connotes an unintended meaning, such as looking askance or a quizzical head tilt.

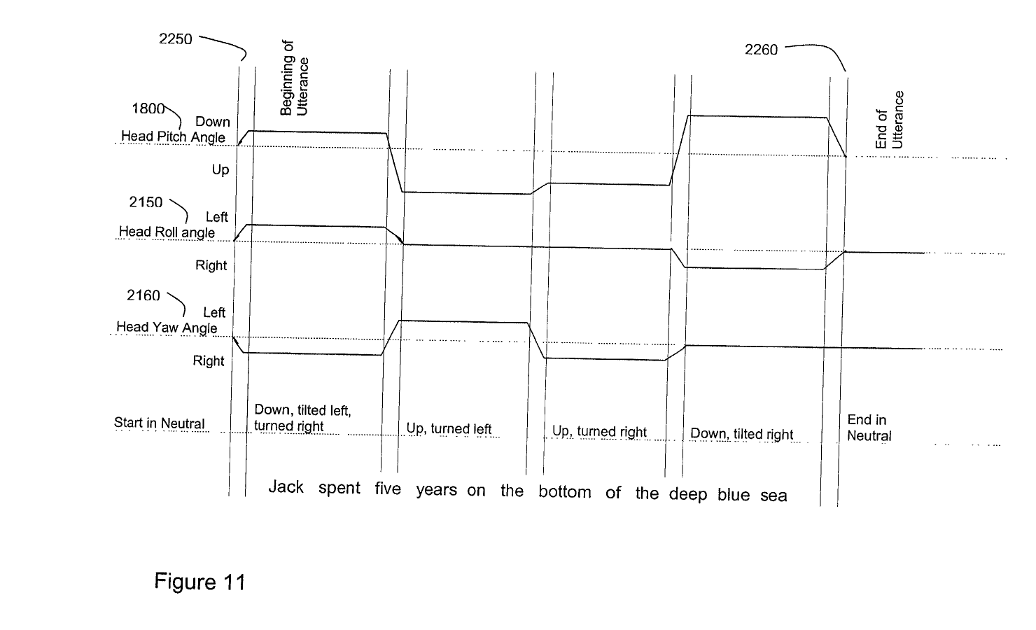

FIG. 11 shows an example of the head orientation states and transitions for the utterance “Jack spent five years on the bottom of the deep blue sea.” The head orientation states are shown as a function of head pitch angle 1800, head roll angle 2150, and head yaw angle 2160. The various orientations are chosen according to Table 3 as described above, and may be summed such that the various orientations are not mutually exclusive. Before the beginning of the utterance 2250 and after the end of the utterance 2260, the head state is a neutral state.

The Speech Movement Implementation has an independent set of states and rules that govern the quick motion of the eyes as they scan the face of the listener. Such eye motion is referred to herein as “eye jitter.” The table for the eye motion states is nearly identical to Table 3 for orientation, except that the eyes rotate only about two axes. Again the transition time is globally defined. In this case a rate of speech multiplier is not used, because this movement does not depend on the rate of speech.

The Speech Movement Implementation establishes a rule for choosing the state for eye jitter. The rule for eye jitter is that each state is held for a given duration, a new state is chosen based on a set of probabilities, the eye motion transitions using the transition time. Unlike head orientation, only one eye position state is chosen, and consequently the positions are never summed.

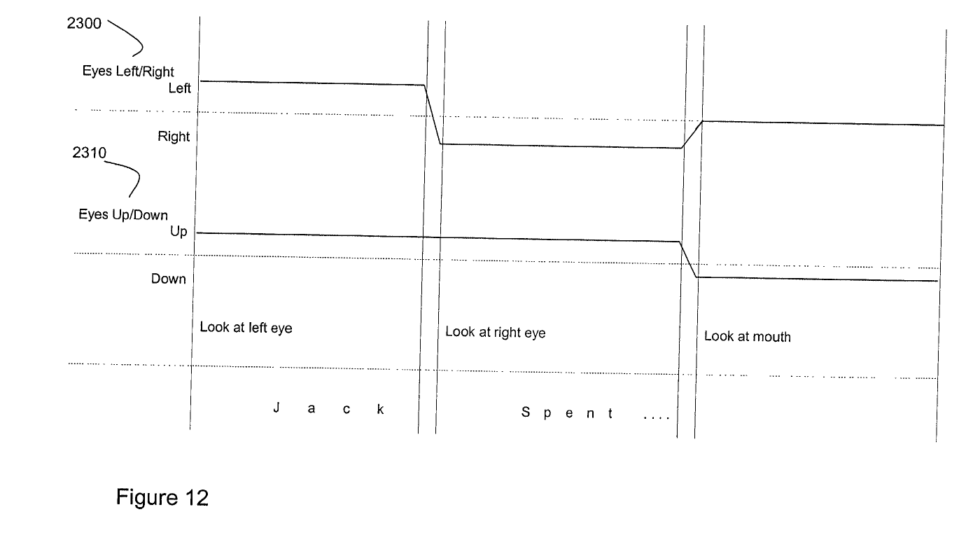

FIG. 12 is shows the eye jitter states and transitions for the utterance “Jack spent five years on the bottom of the deep blue sea.” The eye motion is shown as a function of left/right motion 2300 and up/down motion 2310.

As would be understood by one of ordinary skill in the art, any number of state tables and rules can be used to control background movement. For example, a state table could contain a set of facial expressions which vary in the degree to which they appear “relaxed”, to be chosen based on the rate of speech, on/off characteristics, or other inputs. Another state table might drive weight shifting behavior of a character. Any set of states can be controlled by the Speech Movement Implementation provided that the states can be consistently and appropriately chosen, and their transitions defined, using rules which operate only on the inputs derived from the audio source.

What is claimed is:

1. A method of simulating movement during speech, comprising:
generating gestures based on at least one of: the features of linguistic stress, the on/off characteristics of speech, and the rate of speech.

2. The method of claim 1, further comprising:
approximating the features of linguistic stress.

3. The method of claim 2, wherein said approximating features comprises:
deriving a sequence of phonemes from an audio source;
analyzing the audio source to derive an amplitude integral and energy of vowel segments;
determining from said amplitude integral and said energy of vowel segments whether each vowel is stressed or unstressed; and
for each stressed vowel, calculating the strength of the stress based on said amplitude integral and said energy of vowel segments.

4. The method of claim 2, wherein said generating gestures further comprises:
assigning gestures to stresses based on at least one of: the features of the stress, the relationships between stresses, and the on/off characteristics of speech; and
aligning stresses temporally based on at least one of: the features of the stress, the relationships between stresses, and the on/off characteristics of speech

5. The method of claim 2, wherein said generating gestures further comprises:
formulating rules which introduce, modify, or delete gestures based on at least one of: the on/off characteristics of speech, the rate of speech, and linguistic stress; and
applying said rules.

6. The method of claim 2, further comprising:
generating background movement based on at least one of: features of linguistic stress, on/off characteristics of speech, and rate of speech.

7. The method of claim 4, wherein the features of stress are at least one of:
a time of the stress;
a strength of the stress;
a pitch of the stress;
a duration of the stress;
an interval between the stress and a next and previous stress;
a first stress in an utterance;
a last stress in an utterance; and
a rate of speech at the stress.

8. The method of claim 4, further comprising:
categorizing stresses into at least one category based on at least one of: the features of the stress, the relationships between stresses, and on/off characteristics of speech.

9. The method of claim 4, wherein said aligning gestures to stresses further comprises:
.defining a center time for each gesture, wherein each gesture has elements of movement associated therewith;
defining a center time for each stress; and
aligning said elements, wherein said center time for each gesture and said center time for each stress is equal.

10. The method of claim 6, further comprising:
defining at least two positional states;
choosing said positional state based on at least one of: features of linguistic stress, on/off characteristics of speech, and rate of speech.

11. The method of claim 8, wherein said category is selected from the group comprising:
an initial stress, if the stress is at the beginning of an utterance;a final stress, if the stress is at the end of an utterance;
a quick stress, if the stress is separated from the next nearest stress by less than a first time interval;
an isolated stress, if the stress is separated from the next nearest stress by more than the second time interval;
a long stress, if the length of the stress is greater than a third time interval;
a short stress, if the length of the stress is less than the fourth time interval;
a high stress, if the pitch of the stress is greater than a first pitch level;
a low stress, if the pitch of the stress is lower than a second pitch level;
a rising stress, if the pitch of the stress rises over time;
a declining stress, if the pitch of the stress lowers over time;
a fast stress, if the stress occurs at a time when the rate of speech is higher than a first rate of speech; and
a slow stress, if the stress occurs at a time when the rate of speech is lower than a second rate of speech.

12. The method of claim 9, further comprising:
adjusting said elements based on the rate of speech.

13. The method of claim 12, wherein said adjusting said elements further comprises:
calculating a stretch/compress coefficient; and
applying said stretch/compress coefficient to said elements.

14. A system for simulating movement during speech, comprising:
a computer system;
a program stored on said computer system for generating an animated character; and
said program being configured to generate gestures for said animated character based on at least one of: the features of linguistic stress, the on/off characteristics of speech, and the rate of speech.

15. The system of claim 14, wherein said program is further configured to approximate the features of linguistic stress by deriving a sequence of phonemes from an audio source, analyze the audio source to derive an amplitude integral and energy of vowel segments, determining from said amplitude integral and said energy of vowel segments whether each vowel is stressed or unstressed, and calculating the strength of the stress based on said amplitude integral and said energy of vowel segments.

16. The system of claim 15, wherein said program is further configured to assign gestures to stresses based on at least one of: the features of the stress, the relationships between stresses, and the on/off characteristics of speech, and to align the stresses temporally.

17. The system of claim 15, wherein said program is further configured to categorize stress based on the characteristics of each stress, the relationships between stresses, and relationships between the stresses and the on/off characteristics of speech.

18. The system of claim 15, wherein said program is further configured to formulate and apply rules to introduce, modify, or delete gestures based on at least one of: the on/off characteristics of speech, the rate of speech, and linguistic stress..

19. The system of claim 15, wherein said program is further configured to generate background movement based on at least one of: features of linguistic stress, on/off characteristics of speech, and rate of speech.

20. The system of claim 16, wherein said gestures further comprise elements of motion; and said program is further configured to adjust said elements based on the rate of speech.

21. The system of claim 18, wherein said program is further configured to calculate a stretch/compress coefficient, and apply said stretch/compress coefficient to said elements.
